(19) United States
(12) Patent Application Publication
(10) Pub. No.: US 2019/0219716 A1
(43) Pub. Date: Jul. 18, 2019

(54) Classifying Well Data Using A Support Vector Machine

(71) Applicant: LANDMARK GRAPHICS CORPORATION, Houston, TX (US)

(72) Inventors: Thomas Bartholomew O'Toole, Berkshire (GB); Raquel Morag Velasco, Houston, TX (US)

(21) Appl. No.: 16/332,324

(22) PCT Filed: Oct. 20, 2016
(86) PCT No.: PCT/US2016/057948

§ 371 Date: Mar. 11, 2019

(51) Int. Cl. G01V 1/28; G01V 1/42; G01V 1/50; G06K 9/62; G06N 20/10

(52) U.S. Cl. CPC G01V 1/288; G01V 1/42; G01V 1/50; G06K 9/6269; G01V 2210/1429; G01V 2210/74; G01V 2210/646; G01V 2210/1234; G06N 20/10

(57) ABSTRACT

A computing device can use a support vector machine to categorize well data as being associated with a noise event or a microseismic event. For example, the computing device can determine well data based on sensor signals from a sensor in a wellbore. The computing device can then use the support vector machine to categorize the well data as being associated with a noise event or a microseismic event.

### TECHNICAL FIELD

The present disclosure relates generally to devices used with wells. More specifically, but not by way of limitation, this disclosure relates to using a support vector machine to classify well data.

### BACKGROUND

A well (e.g., an oil or gas well) can include a wellbore drilled through a subterranean formation. The wellbore can include perforations. Fluid can be injected through the perforations to create fractures in the subterranean formation in a process referred to as hydraulic fracturing. The fractures can enable hydrocarbons to flow from the subterranean formation into the wellbore, from which the hydrocarbons can be extracted.

### BRIEF DESCRIPTION OF THE DRAWINGS

FIG. 1 is a cross-sectional side view of an example of a well that includes a computing device for classifying well data according to some aspects.

FIG. 2 is a block diagram of an example of the computing device of FIG. 1 according to some aspects.

FIG. 3 is a flow chart showing an example of a process for training a support vector machine according to some aspects.

FIG. 4 is a flow chart showing an example of a process for using a support vector machine to categorize data according to some aspects.

### DETAILED DESCRIPTION

Certain aspects and features of the present disclosure relate to classifying well data as being associated with a microseismic event or a noise event using a support vector machine. Well data can include any information related to, about, or associated with a well (e.g., a well that is used for extracting hydrocarbons from a subterranean formation). A microseismic event can result from the creation of a fracture in the subterranean formation. A noise event can be any event other than a desired type of event, such as a microseismic event. A support vector machine can include a machine-learning model that can classify an input into a particular category from among multiple potential categories.

In some examples, the support vector machine can include a virtual coordinate system that has a predefined number of dimensions, such as 100 dimensions. The support vector machine may have previously (e.g., during a training process) defined a plane that extends through the virtual coordinate system and separates all of the dimensions within the virtual coordinate system into either a first region or a second region. The support vector machine can receive the well data and assign a point to the well data within the virtual coordinate system. The point can fall within the first region or the second region. The support vector machine can then classify the well data as belonging to a category associated with that region. For example, the point can fall within the first region. The support vector machine can then classify the well data as belonging to a category associated with the first region. In some examples, the category can be a noise-event category (indicating that the well data is associated with a noise event) or a microseismic-event category (indicating that the well data is associated with a microseismic event).

As a particular example, a well operator may wish to obtain hydrocarbons from a subterranean formation. To obtain the hydrocarbons, the well operator can perform hydraulic fracturing by injecting fluid at high pressure into the subterranean formation. The high pressure of the fluid can cause stresses on the rock in the subterranean formation to change, causing the rock to slip or shear along a preexisting zone of weakness (e.g., a fault) and/or create a new fracture along which slip can also occur. Such a slip or shear can be a microseismic event. The microseismic event can generate elastic waves (e.g., an acoustic wave or shear wave) that propagate through the subterranean formation. The elastic waves can be detected using an array of geophones, and may be used to determine important information about the fracture. For example, information representing the detected elastic waves can be used to generate a model of one or more fractures extending through the subterranean formation. The well operator may rely on this model to make decisions. But the geophones can also detect other elastic waves, which can be referred to as noise, generated as a result of other events, which can be referred to as noise events. Examples of sources of noise events can include a movement or use of a piece of equipment, a distant earthquake, etc. The noise events may inadvertently be misidentified as microseismic events, leading to errors in the model.

It can be challenging to distinguish noise events from microseismic events. For example, elastic waves from microseismic events can have relatively low amplitudes, whereas noise generated downhole and at the surface of the subterranean formation can have relatively high amplitudes. This can result in low signal-to-noise ratios, enabling noise events to be easily misinterpreted as microseismic events. In some instances, human experts can manually review data associated with the elastic waves to distinguish the noise events from true microseismic events. But the manual review process can be inaccurate, slow, expensive, requires specific training, and results can vary based on the biases of the individual experts.

Some examples of the present disclosure overcome one or more of these issues by using a support vector machine to distinguish noise events from microseismic events. For example, support vector machines can be more versatile and more accurate than other methods. Support vector machines can work with various types of input, such as raw observations (e.g., seismic traces or other raw data from a sensor) or data derived from the raw observations (e.g., images, such as seismic images). Support vector machines can also be relatively simple to build and train as compared to other kinds of machine-learning methods, such as neural networks. This may make support vector machines particularly well suited for analyzing data (e.g., in real time) using limited computational resources, such as the computational resources available at a well site.

Further, support vector machines can be cheaper and faster than other methods. For example, a data set of 8000 events (e.g., noise events and microseismic events) can be classified in less than five minutes using a support vector machine. A human expert can likely only classify five events in that same time period.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

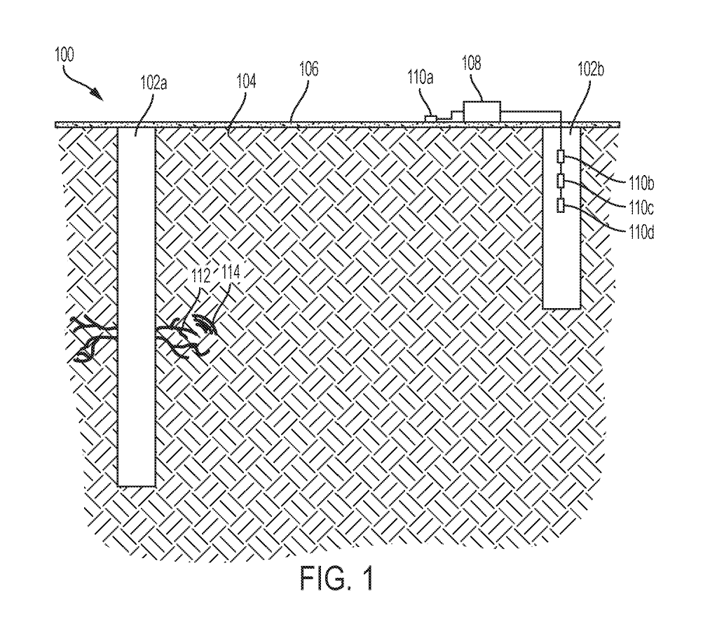

FIG. 1 is a cross-sectional side view of an example of a well 100 that includes a computing device 108 for classifying well data according to some aspects. The well 100 can include wellbores 102a-b extending through various earth strata that form a subterranean formation 104. The wellbores 102a-b can be vertical, deviated, horizontal, or any combination of these.

In some examples, hydraulic fracturing can be performed in the well 100 to generate a fracture 112. For example, fluid can be pumped through perforations in the wellbore 102a to create the fracture 112. The fracture 112 can enable hydrocarbons to flow from the subterranean formation 104 into the wellbore 102a. Creation of the fracture 112 can result in microseismic events that result in elastic waves 114 being propagated through the subterranean formation 104.

The elastic waves 114 can be detected by one or more sensors 110a-d (e.g., a microphone; accelerometer; geophone; distributed fiber optic sensor, such as a distributed acoustic sensor; tiltmeter; or any combination of these). In some examples, at least one of the sensors 110a-d can be positioned at a surface 106 of the subterranean formation 104, as shown by sensor 110a located at the surface 106. Additionally or alternatively, at least one of the sensors 110a-d can be positioned in a nearby wellbore 102b, as shown by sensors 110b-d located in the wellbore 102b that is within a certain distance from the wellbore 102a. The distance can vary, but in some examples the wellbore 102b can be a wellbore that is closest among multiple wellbores to the wellbore 102a. Additionally or alternatively, at least one of the sensors 110a-d can be positioned in the wellbore 102a itself. In some examples, all of the sensors 110a-d can be positioned in the wellbore 102a.

The sensors 110a-d can be communicatively coupled to the computing device 108 via a wired or wireless link. The computing device 108 can receive sensor data from the sensors 110a-d. The computing device 108 can determine well data from the sensor data. The computing device 108 can use a support vector machine to analyze the well data. For example, the computing device 108 can use the support vector machine to categorize the well data as being associated with a noise event or a desired type of event (e.g., a microseismic event). The computing device 108 can additionally or alternatively use other types of classifiers to classify the well data. Examples of other types of classifiers can include a neural network, a Naïve-Bayes classifier, a decision tree, a nearest neighbor classifier, a random forest classifier, or any combination of these.

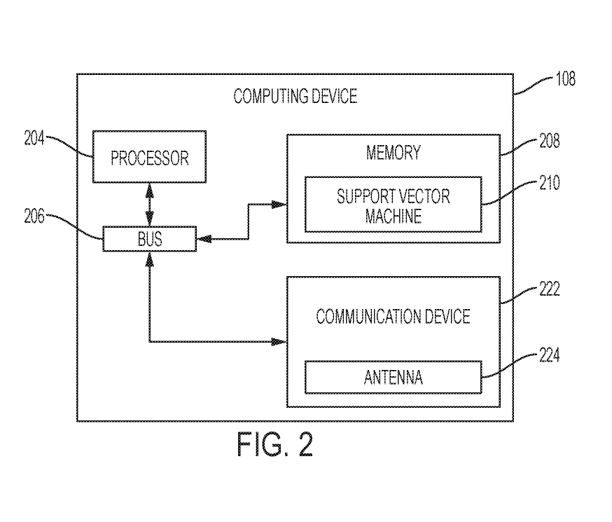

FIG. 2 is a block diagram of an example of the computing device 108 of FIG. 1 according to some aspects. The computing device 108 can include a processor 204, a memory 208, a bus 206, and a communication device 222. In some examples, some or all of the components shown in FIG. 2 can be integrated into a single structure, such as a single housing. In other examples, some or all of the components shown in FIG. 2 can be distributed (e.g., in separate housings) and in electrical communication with each other.

The processor 204 can execute one or more operations for classifying well data. The processor 204 can execute instructions stored in the memory 208 to perform the operations. The processor 204 can include one processing device or multiple processing devices. Non-limiting examples of the processor 204 include a Field-Programmable Gate Array (“FPGA”), an application-specific integrated circuit (“ASIC”), a microprocessor, etc.

The processor 204 can be communicatively coupled to the memory 208 via the bus 206. The non-volatile memory 208 may include any type of memory device that retains stored information when powered off. Non-limiting examples of the memory 208 include electrically erasable and programmable read-only memory (“EEPROM”), flash memory, or any other type of non-volatile memory. In some examples, at least some of the memory 208 can include a medium from which the processor 204 can read instructions. A computer-readable medium can include electronic, optical, magnetic, or other storage devices capable of providing the processor 204 with computer-readable instructions or other program code. Non-limiting examples of a computer-readable medium include (but are not limited to) magnetic disk(s), memory chip(s), read-only memory (ROM), random-access memory (“RAM”), an ASIC, a configured processor, optical storage, or any other medium from which a computer processor can read instructions. The instructions can include processor-specific instructions generated by a compiler or an interpreter from code written in any suitable computer-programming language, including, for example, C, C++, C#, etc.

The communication device 222 can be implemented using hardware, software, or both. The communication device 222 can receive communications from, and transmit communications to, a sensor (e.g., sensors 110a-d of FIG. 1). The communication device 222 can include a wired or wireless interface for communicating with the sensor. For example, the communication device 222 can include an antenna 224 for wirelessly communicating with the sensor. In some examples, the communication device 222 can include hardware or software configured to allow the communication device 222 to receive signals from the sensor and amplify, filter, modulate, de-modulate, frequency shift, and otherwise manipulate the signals. The communication device 222 can transmit the manipulated signals to the processor 204 for further processing.

The memory 208 can include a support vector machine 210 or another type of classifier for categorizing well data. Examples of other types of classifiers can include a neural network, a Naïve-Bayes classifier, a decision tree, a nearest neighbor classifier, a random forest classifier, or any combination of these.

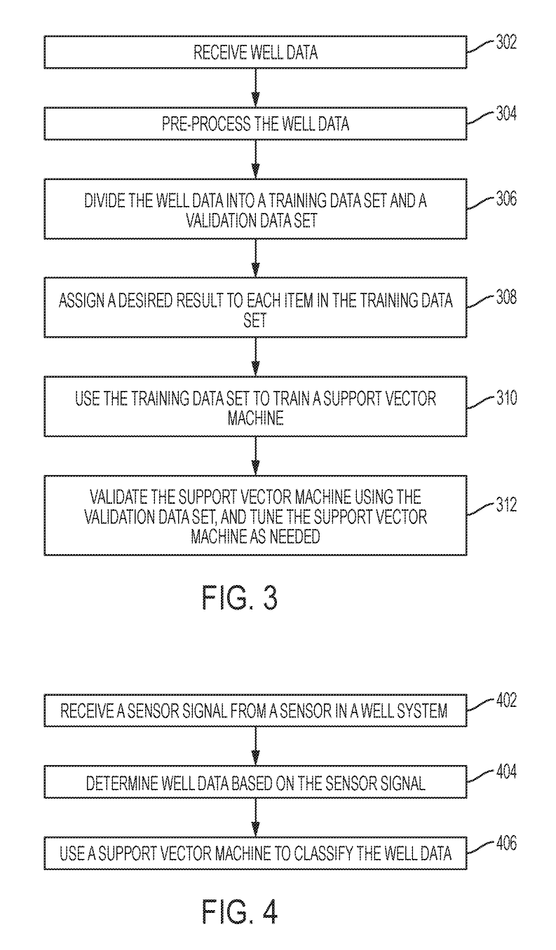

In some examples, the support vector machine 210 is trained before the support vector machine 210 is used to classify well data. FIG. 3 is a flow chart showing an example of a process for training the support vector machine 210 according to some aspects. Some examples can include more, fewer, or different steps than the steps depicted in FIG. 3. Also, some examples can implement the steps of the process in a different order. The steps below are described with reference to the components described above with regard to FIG. 2, but other implementations are possible.

In block 302, the computing device 108 receives well data. Examples of the well data can include seismic data (e.g., seismic traces), ground-movement data, vibration data, acoustic data, temperature data, pressure data, or any combination of these. In some examples, the computing device 108 can receive the well data from a sensor (e.g., sensors 110a-d of FIG. 1) in the well. For example, the computing device 108 can receive the seismic data or the ground-movement data from a geophone, the temperature data from a thermometer, the pressure data from a pressure sensor, etc. As another example, the computing device 108 can receive the well data from a fiber optic sensor. In some examples, the well data can be associated with a microseismic event or another event occurring in the wellbore or a surrounding subterranean formation.

Additionally or alternatively, the computing device 108 can receive the well data as user input or via a network. For example, the computing device can download the well data via the Internet, or receive the well data as user input via a keyboard or touchscreen.

In some examples, the user can create or otherwise provide synthetic data for use as the well data. The user may create or otherwise provide the synthetic data for the purpose of training the support vector machine.

In some examples, the data can include images, such as microseismic images associated with microseismic events. The images can be formed using synthetic data or sensor signals from sensors in the well. The images may be formed for the purpose of training the support vector machine.

In block 304, the computing device 108 pre-processes the well data. For example, the computing device 108 can modify the well data into a new or different form and use the modified well data as the well data. For example, the computing device 108 can filter, smooth, collate, combine, divide, or otherwise modify the well data until the well data is in a desired format. The computing device 108 can then use the well data in the desired format as the well data.

In some examples, the computing device 108 can use the well data to generate image volumes, waveform substacks, a diffraction-stack migrated image, or any combination of these. In some examples, an image volume can include an N-dimensional array of scalar values corresponding to stack amplitudes (or other attributes) at each spatio-temporal point in a subsurface volume of interest. The image volume can be turned into a 1-dimensional array (e.g., vectorized) in order to be used by the support vector machine. In some examples, a waveform substack can include a summation of a group of seismic (or other) traces from a selection of sensor locations that has been made according to a predetermined criterion (e.g., distance or azimuth from a microseismic event). A seismic trace can include data from a geophone or other sensor that measures ground movement. The waveform substack can highlight coherent signals that are indicative of a microseismic event versus incoherent noise signals. In some examples, a diffraction-stack migrated image can be a visual representation of a location of a microseismic event that occurred in a subterranean formation. The diffraction-stack migrated image can be generated by applying a mathematical operation (e.g., a summation) to a set of seismic traces after a travel-time correction has been applied to the seismic traces. The travel-time correction can include removing, offsetting, or otherwise correcting a time delay between when a microseismic event occurred that generated an elastic wave and when a sensor actually detected the elastic wave.

For example, the computing device 108 can receive sensor signals from geophones and generate a vectorized image volume, a waveform substack, a diffraction-stack migrated image, or any combination of these based on the sensor signals. The computing device 108 can use the vectorized image volume, the waveform substack, the diffraction-stack migrated image, or any combination of these as the well data.

In block 306, the computing device 108 divides the well data (e.g., the pre-processed data) into a training data set and a validation data set. For example, the computing device 108 can allocate half of the well data for use as the training data set and the other half of the well data for use as the validation data set. The training data set can be used for training the support vector machine. The validation data set can be used for determining the accuracy of the support vector machine after the support vector machine has been trained (e.g., as described in block 312).

Alternatively, the computing device 108 can use synthetically generated data as the training data set, the validation data set, or both of these. For example, the computing device 108 use a training data set that was artificially generated to train the support vector machine (e.g., prior to any actual well data being acquired).

In some examples, the amount of data in the training data set or the type of data in the training data set can depend on the expected variability of the subsequent well data to be categorized by the support vector machine. Better results may be obtained if the training data set has the same degree of variation expected in the subsequent well data.

In block 308, the computing device 108 can assign a desired result to each item in the training data set. For example, the computing device 108 can receive user input designating each respective item in the training data set as being associated with a noise event or a desired event (e.g., a microseismic event). Based on the user input, the computing device 108 can tag each respective item in the training data set as a noise event or a desired event. For example, the computing device 108 can associate each respective item in the training data set with a noise event or a microseismic event. In this manner, the training data set can be formed using manual annotation.

As a particular example, the training data set can include vectorized image volumes of microseismic events. The computing device 108 can receive user input indicating whether each vectorized image volume is associated with a microseismic event or a noise event. The computing device 108 can then categorize each vectorized image volume in the training data set as being associated with a microseismic event or a noise event based on the corresponding user input.

In block 310, the computing device 108 uses the training data set to train the support vector machine. Training the support vector machine can include inputting the training data into the support vector machine so that the support vector machine can define a mapping between the items in the training data and their desired results. The support vector machine can analyze each item in the training data to identify features of the item that are significant, and can determine how much weight to assign to each of these features to obtain the corresponding desired result. In some examples, the support vector machine can identify, and assign weights to, more relevant features than a human can. Thus, the mapping defined by the support vector machine can be more complex, more accurate, and account for more features than human judgment (e.g., the human judgement on which the training data classification was originally based).

More specifically, training the support vector machine can include providing the training data set as input to the support vector machine. The support vector machine can determine respective points in a virtual coordinate system (e.g., vector space) for each item in the training data set based on the characteristics of the item. For example, each item in the training data set can be an image that is 10 pixels by 10 pixels in size. The support vector machine can represent each of the 100 pixels in an image as a dimension in the virtual coordinate system (e.g., vector space), so that there are 100 dimensions in the virtual coordinate system. The support vector machine can determine a particular point for a particular image in the training data set based on the values of the pixels in the image. The support vector machine can repeat this process to define points in the virtual coordinate system for some or all of the images in the training data set. Thereafter, the support vector machine can define (e.g., optimally define) one or more planes (e.g., hyperplanes) that extend through the virtual coordinate system, separating the points into groups of points. The support vector machine can define the one or more planes based on the respective category associated with each point (e.g., the respective category associated with the item in the training data set represented by the point). Each group of points defined by the one or more planes can represent a category into which future inputs can be classified.

Training a support vector machine using a training data set can be referred to as supervised learning. Some examples may not include a training data set that is manually annotated. In such examples, the support vector machine can be trained using a dataset that has been annotated or classified using an unsupervised learning method, such as a clustering-based learning method. Any suitable supervised or unsupervised approach for training the support vector machine can be used.

In block 312, the computing device 108 validates the support vector machine using the validation data set. The computing device 108 can additionally tune the support vector machine to increase the accuracy of the support vector machine.

For example, the computing device 108 can provide the validation data set as input to the support vector machine. A user can manually analyze the output from the support vector machine to determine if the output is correct or incorrect. If the output is incorrect, the user may provide input to the computing device 108 to tune one or more parameters of the support vector machine. The computing device 108 can receive the user input and, in response, modify the one or more parameters of the support vector machine. This can increase the accuracy of the classifications output by the support vector machine.

FIG. 4 is a flow chart showing an example of a process for using a support vector machine to categorize data according to some aspects. Some examples can include more, fewer, or different steps than the steps depicted in FIG. 4. Also, some examples can implement the steps of the process in a different order. The steps below are described with reference to the components described above with regard to FIG. 2, but other implementations are possible.

In block 402, the computing device 108 receives a sensor signal from a sensor in a well (e.g., the sensors 110a-d of FIG. 1). The sensor signal can be in an analog form or a digital form. In some examples, the sensor signal can be associated with a microseismic event in a subterranean formation.

In block 404, the computing device 108 determines well data based on the sensor signal (e.g., the well data can be derived from or obtained from the sensor signal). In some examples, the computing device 108 can extract the well data from the sensor signal. For example, the well data can include an amplitude, frequency, duration, waveform, or any combination of these of the sensor signal. As another example, the well data can include digital information carried by the sensor signal.

Additionally or alternatively, the computing device 108 can process the sensor signal to determine the well data. For example, the computing device 108 can filter, smooth, collate, combine, divide, or otherwise manipulate the sensor signal to generate or determine the well data.

Additionally or alternatively, the computing device 108 can generate an image based on the sensor signal. For example, the computing device can generate a vectorized image volume, a waveform substack, a microseismic image, or any combination of these based on the sensor signal. The computing device 108 can use the image as the well data.

In block 406, the computing device 108 uses a support vector machine to classify the well data. The support vector machine may have been trained using any of the methods discussed with respect to FIG. 3. In some examples, the support vector machine can classify the well data into a particular category from among at least two categories. The at least two categories can include a first category that is associated with a noise event and a second category that is associated with type of event (e.g., a microseismic event). In some examples, the support vector machine can classify the well data into a particular category from among three or more possible categories.

In some examples, the computing device 108 can output a category for the well data, store the well data in a database associated with the category, or both of these. For example, the computing device 108 can store well data associated with a noise event in one database and well data associated with a microseismic event in another database.

In some examples, the computing device 108 can receive user input indicating whether an output from the support vector machine is correct or incorrect. The computing device 108 can use the user input as feedback to further train the support vector machine. For example, the computing device 108 can receive user input from a keyboard, mouse, touchscreen, or graphical user interface indicating that a particular output from the support vector machine is incorrect. The particular output can be for a particular input. Based on the output being incorrect, the computing device 108 can generate additional training data by associating the particular input with the correct output. The computing device 108 can then use the additional training data to further train the support vector machine.

Although some of the above processes and examples are described with reference to well data and hydrocarbon wells, other examples can be implemented for classifying data associated with microseismic events that occurred in other types of systems. For example, data associated with microseismic events that occurred in a geothermal system, a waste-water system, a carbon-sequestration system, or any combination of these can be analyzed and classified according to one or more of the processes discussed above.

Also, although some of the above processes and examples are described with reference to a support vector machine, some or all of the processes and examples can alternatively be implemented using another type of classifier, such as a neural network.

In some aspects, well data can be classified according to one or more of the following examples:

### Example #1

A system can include a processing device and a memory device that includes instructions for a support vector machine that is executable by the processing device for classifying well data into a particular category from among a first category associated with a noise event and a second category associated with a microseismic event. The well data can be derived from a sensor at a well site or in a wellbore. The microseismic event may have occurred, or can be occurring, in a subterranean formation through which the wellbore is formed.

### Example #2

The system of Example #1 may feature the memory device further including instructions that are executable by the processing device for causing the processing device to generate an image based on a sensor signal from the sensor, and use the image as the well data.

### Example #3

The system of any of Examples #1-2 may feature the memory device further including instructions that are executable by the processing device. The instructions can cause the processing device to store the well data in a first database based on the well data being classified into the first category. The instructions can cause the processing device to store the well data in a second database based on the well data being classified into the second category.

### Example #4

The system of any of Examples #1-3 may feature the memory device further including instructions that are executable by the processing device. The instructions can cause the processing device to receive a data set that includes images associated with microseismic events. The instructions can cause the processing device to receive user input designating each image in the data set as being associated with the noise event or the microseismic event. The instructions can cause the processing device to generate training data by tagging each image in the data set as being associated with the noise event or the microseismic event based on the user input. The instructions can cause the processing device to train the support vector machine using the training data.

### Example #5

The system of any of Examples #1-4 may feature the memory device further including instructions that are executable by the processing device. The instructions can cause the processing device to receive user input (e.g., additional user input) indicating that an output from the support vector machine is incorrect. The instructions can cause the processing device to, based on the output being an incorrect output, generate training data (e.g., additional training data) by associating an input corresponding to the incorrect output with a correct output. The instructions can cause the processing device to train the support vector machine using the training data (e.g., the additional training data).

### Example #6

The system of any of Examples #1-5 may feature the microseismic event including (or resulting from) forming a fracture in the subterranean formation. The well data can be associated with elastic waves generated by the microseismic event.

### Example #7

The system of any of Examples #1-6 may feature the memory device further including instructions that are executable by the processing device for causing the processing device to classify the well data using the support vector machine. The processing device can assign a point in a virtual coordinate system to the well data based on characteristics of the well data. The processing device can determine a category associated with a location of the point in the virtual coordinate system. The category can be the first category or the second category. The processing device can classify the well data as being in the category.

### Example #8

A method can include determining, by a processing device, well data based on a sensor signal from a sensor at a well site or in a wellbore. The method can include classifying, by the processing device and using a support vector machine, the well data into a particular category from among a first category associated with a noise event and a second category associated with a microseismic event.

### Example #9

The method of Example #8 may feature determining the well data by generating an image based on the sensor signal and using the image as the well data.

### Example #10

The method of any of Examples #8-9 may feature storing the well data in a first database based on the well data being associated with the noise event.

### Example #11

The method of any of Examples #8-10 may feature receiving a data set that includes images associated with microseismic events. The method may feature receiving user input designating each image in the data set as being associated with the noise event or the microseismic event. The method may feature generating training data by tagging each image in the data set as being associated with the noise event or the microseismic event based on the user input. The method may feature training the support vector machine using the training data.

### Example #12

The method of any of Examples #8-11 may feature receiving user input (e.g., additional user input) indicating that an output from the support vector machine is incorrect. The method may feature, based on the output being an incorrect output, generating training data (e.g., additional training data) by associating an input corresponding to the incorrect output with a correct output. The method may feature training the support vector machine using the training data (e.g., the additional training data).

### Example #13

The method of any of Examples #8-12 may feature the wellbore being for extracting hydrocarbons from a subterranean formation. The method may feature the sensor being a geophone. The method may feature the microseismic event including (or resulting from) forming a fracture in the subterranean formation. The method may feature the well data being associated with elastic waves generated by the microseismic event.

### Example #14

The method of any of Examples #8-13 may feature classifying the well data using the support vector machine. The method may feature assigning a point in a virtual coordinate system to the well data based on characteristics of the well data. The method may feature determining a category associated with a location of the point in the virtual coordinate system. The category can be the first category or the second category. The method may feature classifying the well data as being in the category.

### Example #15

A non-transitory computer-readable medium that includes instructions for a support vector machine that is executable by a processing device for classifying well data into a particular category from among a first category associated with a noise event and a second category associated with a microseismic event. The well data can be derived from a sensor at a well site or in a wellbore.

### Example #16

The non-transitory computer-readable medium of Example #15 may further include instructions that are executable by the processing device for causing the processing device to generate an image based on a sensor signal from the sensor and use the image as the well data.

### Example #17

The non-transitory computer-readable medium of any of Examples #15-16 may further include instructions that are executable by the processing device for causing the processing device to store the well data in a first database based on the well data being classified into the first category. The instructions can cause the processing device to store the well data in a second database based on the well data being classified into the second category.

### Example #18

The non-transitory computer-readable medium of any of Examples #15-17 may further include instructions that are executable by the processing device for causing the processing device to receive a data set that includes images associated with microseismic events. The instructions can cause the processing device to receive user input designating each image in the data set as being associated with the noise event or the microseismic event. The instructions can cause the processing device to generate training data by tagging each image in the data set as being associated with the noise event or the microseismic event based on the user input. The instructions can cause the processing device to train the support vector machine using the training data.

### Example #19

The non-transitory computer-readable medium of any of Examples #15-18 may further include instructions that are executable by the processing device for causing the processing device to receive additional user input indicating that an output from the support vector machine is incorrect. The instructions can cause the processing device to, based on the output being an incorrect output, generate additional training data by associating an input corresponding to the incorrect output with a correct output. The instructions can cause the processing device to train the support vector machine using the additional training data.

### Example #19

The non-transitory computer-readable medium of any of Examples #15-18 may feature the microseismic event including forming a fracture in a subterranean formation. The well data can be associated with elastic waves generated by the microseismic event. The non-transitory computer-readable medium can further include instructions that are executable by the processing device for causing the processing device to classify the well data using the support vector machine. The instructions can cause the processing device to use the support vector machine to assign a point in a virtual coordinate system to the well data based on characteristics of the well data. The instructions can cause the processing device to use the support vector machine to determine a category associated with a location of the point in the virtual coordinate system. The category can be the first category or the second category. The instructions can cause the processing device to use the support vector machine to classify the well data as being in the category.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

1. A system comprising:
a processing device; and
a memory device that includes instructions for a support vector machine that is executable by the processing device for classifying well data derived from a sensor at a well site or in a wellbore into a particular category from among a first category associated with a noise event and a second category associated with a microseismic event occurring in a subterranean formation through which the wellbore is formed.

2. The system of claim 1, wherein the memory device further includes instructions that are executable by the processing device for causing the processing device to:
generate an image based on a sensor signal from the sensor; and
use the image as the well data.

3. The system of claim 1, wherein the memory device further includes instructions that are executable by the processing device for causing the processing device to:
store the well data in a first database based on the well data being classified into the first category; and
store the well data in a second database based on the well data being classified into the second category.

4. The system of claim 1, wherein the memory device further includes instructions that are executable by the processing device for causing the processing device to:
receive a data set that includes images associated with microseismic events;
receive user input designating each image in the data set as being associated with the noise event or the microseismic event;
generate training data by tagging each image in the data set as being associated with the noise event or the microseismic event based on the user input; and
train the support vector machine using the training data.

5. The system of claim 4, wherein the memory device further includes instructions that are executable by the processing device for causing the processing device to:
receive additional user input indicating that an output from the support vector machine is incorrect;
based on the output being an incorrect output, generate additional training data by associating an input corresponding to the incorrect output with a correct output; and
train the support vector machine using the additional training data.

6. The system of claim 1, wherein the microseismic event includes forming a fracture in the subterranean formation and the well data is associated with elastic waves generated by the microseismic event.

7. The system of claim 1, wherein the memory device further includes instructions that are executable by the processing device for causing the processing device to classify the well data using the support vector machine by:
assigning a point in a virtual coordinate system to the well data based on characteristics of the well data;
determining a category associated with a location of the point in the virtual coordinate system, the category being the first category or the second category; and
classifying the well data as being in the category.

8. A method comprising:
determining, by a processing device, well data based on a sensor signal from a sensor at a well site or in a wellbore; and
classifying, by the processing device and using a support vector machine, the well data into a particular category from among a first category associated with a noise event and a second category associated with a microseismic event.

9. The method of claim 8, further comprising determining the well data by:
generating an image based on the sensor signal; and
using the image as the well data.

10. The method of claim 8, further comprising storing the well data in a first database based on the well data being associated with the noise event.

11. The method of claim 8, further comprising:
receiving a data set that includes images associated with microseismic events;
receiving user input designating each image in the data set as being associated with the noise event or the microseismic event;
generating training data by tagging each image in the data set as being associated with the noise event or the microseismic event based on the user input; and
training the support vector machine using the training data.

12. The method of claim 11, further comprising:
receiving additional user input indicating that an output from the support vector machine is incorrect;
based on the output being an incorrect output, generating additional training data by associating an input corresponding to the incorrect output with a correct output; and
training the support vector machine using the additional training data.

13. The method of claim 8, wherein:
the wellbore is for extracting hydrocarbons from a subterranean formation;
the sensor is a geophone;
the microseismic event includes forming a fracture in the subterranean formation; and
the well data is associated with elastic waves generated by the microseismic event.

14. The method of claim 8, further comprising classifying the well data using the support vector machine by:
assigning a point in a virtual coordinate system to the well data based on characteristics of the well data;
determining a category associated with a location of the point in the virtual coordinate system, the category being the first category or the second category; and
classifying the well data as being in the category.

15. A non-transitory computer-readable medium that includes instructions for a support vector machine that is executable by a processing device for classifying well data derived from a sensor at a well site or in a wellbore into a particular category from among a first category associated with a noise event and a second category associated with a microseismic event.

16. The non-transitory computer-readable medium of claim 15, further comprising instructions that are executable by the processing device for causing the processing device to:
generate an image based on a sensor signal from the sensor; and
use the image as the well data.

17. The non-transitory computer-readable medium of claim 15, further comprising instructions that are executable by the processing device for causing the processing device to:
store the well data in a first database based on the well data being classified into the first category; and
store the well data in a second database based on the well data being classified into the second category.

18. The non-transitory computer-readable medium of claim 15, further comprising instructions that are executable by the processing device for causing the processing device to:
receive a data set that includes images associated with microseismic events;
receive user input designating each image in the data set as being associated with the noise event or the microseismic event;
generate training data by tagging each image in the data set as being associated with the noise event or the microseismic event based on the user input; and
train the support vector machine using the training data.

19. The non-transitory computer-readable medium of claim 18, further comprising instructions that are executable by the processing device for causing the processing device to:
receive additional user input indicating that an output from the support vector machine is incorrect;
based on the output being an incorrect output, generate additional training data by associating an input corresponding to the incorrect output with a correct output; and
train the support vector machine using the additional training data.

20. The non-transitory computer-readable medium of claim 15, wherein the microseismic event includes forming a fracture in a subterranean formation and the well data is associated with elastic waves generated by the microseismic event, and further comprising instructions that are executable by the processing device for causing the processing device to classify the well data using the support vector machine by:
assigning a point in a virtual coordinate system to the well data based on characteristics of the well data;
determining a category associated with a location of the point in the virtual coordinate system, the category being the first category or the second category; and
classifying the well data as being in the category.

21.-35. (canceled)
